(19) United States
(12) Patent Application Publication
(10) Pub. No.: US 2004/0161316 A1
(43) Pub. Date: Aug. 19, 2004

(54) Tubular mining bolt and method

(75) Inventors: Frank M. Locotos, Bridgeville, PA (US); Walter J. Simmons, Martinsburg, WV (US); Walter N. Simmons, Durham, NC (US); James Kevin Staffler, Twinsburg, OH (US); Robert T. Macaul, Pittsburgh, PA (US)

Correspondence Address: Ansel M. Schwartz, Suite 304, 201 N. Craig Street, Pittsburgh, PA, 15213, US

(73) Assignees: F.M. Locotos Co., Inc.; Terrasimco, Inc.; Copperweld Marketing and Sales Company; Maverick Tube Corporation

(21) Appl. No.: 10/368,842

(22) Filed: Feb. 19, 2003

(51) Int. Cl. F16B 39/02; E21D 20/00; E21D 21/00

(52) U.S. Cl. 411/82; 405/259.1; 405/259.5

(57) ABSTRACT

A mine bolt for a bore hole in a roof of a mine. The bolt comprises a tube having a cross-sectional diameter less than that of the bore hole, a hollow interior, a first end, and a second end having an opening in communication with the hollow interior. The bolt comprises a flange disposed adjacent to the second end. The bolt can include an anchor means implaced in the tube and an elongated member disposed in the tube and extending from the anchor means out the tube to the second end. A method for supporting a mine roof. A method of forming a mine bolt.

### CROSS-REFERENCE

This application is related to contemporaneously filed U.S. patent application serial Ser. No. ______ titled “Radially Deformed Anchorage Bolt” by Walter J. Simmons, Walter N. Simmons, Frank M. Locotos, James Kevin Staffler and Robert T. Macaul, having attorney docket number LTV-2, incorporated by reference herein.

### FIELD OF THE INVENTION

The present invention is related to mine roof supports. More specifically, the present invention is related to a mining bolt which has a hollow interior and an open second end.

### BACKGROUND OF THE INVENTION

It is a well established practice in underground mining work, such as coal mining, tunnel excavation, or the like, to reinforce the roof of the mine to prevent its collapse. There are various types of reinforcement apparatus, the most common are of the mining bolt type. These mining bolts are of various designs.

Split-Set® by Ingersoll-Rand is a mining bolt which is comprised of a c-shaped metal member which is forced into a bore hole and supports the rock by friction. The hollow shape of the Split-Set® bolt allows the bolt to deform rather than break when a rock shift occurs. Unfortunately, the c-shape is not a conventional shape and thus is costly to manufacture.

Swellex® by Atlas Copco, Inc. of Sweden is a hollow folded c-shaped tube which expands in the bore hole by means of high pressure water. During the swelling process, the Swellex® bolt adapts to fit the irregularities of the bore hole. The hollow shape allows the tube to deform during rock shifts. Unfortunately, the complex shape of the Swellex® mining bolt is expensive to manufacture. Further, the necessary high pressure water tools and fittings add to the expense and complexity of the method.

Spin-Lock® by Williams Co. discloses a rock bolt which has a hollow interior and has open ends for allowing grout to be pumped therethrough. No resin cartridges are disclosed.

The present invention describes a mining bolt which can be made from inexpensive, stock round tubing. The hollow interior of the tubing allows the mining bolt of the present invention to deform during rock shifts instead of breaking. Further, the grouted hollow mining bolt of the present invention provides greater anchorage strength as compared with a grouted solid mining bolt with an equal amount of steel and can be spun from its open second end.

### SUMMARY OF THE INVENTION

The present invention pertains to a method for supporting rock in a mine. The method comprises the steps of breaking a resin cartridge in a bore hole in a mine roof with a first end of a mine bolt. There is the step of rotating the tube of the mine bolt disposed in the bore hole from a second end of the tube with a bolting machine connected to an insertion tool that contacts the second end and preferably extends into the hollow interior of the tube through an opening in the second end.

The present invention pertains to a mine bolt for insertion in a bore hole. The bolt comprises a tube having a cross-sectional diameter less than that of the bore hole, a hollow interior, a first end, and a second end having an opening in communication with the hollow interior preferably through which a tool can be inserted to turn the tube from the second end. The bolt comprises a flange disposed adjacent to the second end. The bolt comprises an anchor means implaced in the tube. The bolt comprises an elongated member disposed in the tube and extending from the anchor means out the tube to the second end.

The present invention pertains to a method of forming a mine bolt. The method comprises the steps of swaging closed a first end of a tube. There is the step of forming a flange in the tube in proximity to a second end of the tube while maintaining the second end of the tube open. Alternatively, a cap can be placed on the first end of the tube to close the first end.

The present invention pertains to a grouted mine bolt for a bore hole in rock of a mine. The bolt comprises an elongate member having a cross-sectional diameter less than that of the bore hole, a first end, and a second end. The bolt comprises a resin cartridge holder for holding a resin cartridge. The holder is connected to the first end. The bolt comprises a flange disposed adjacent to the second end.

### BRIEF DESCRIPTION OF THE DRAWINGS

In the accompanying drawings, the preferred embodiment of the invention and preferred methods of practicing the invention are illustrated in which:

FIG. 1 is a schematic representation of a mine bolt of the present invention.

FIG. 2 is a bottom view of the mine bolt having a cross-section with at least one flat side.

FIG. 3 is a schematic representation of a cross-section of the tube of the mine bolt having a closed perimeter.

FIG. 4 is a schematic representation of a cross-section of a first end of the tube with a plug.

FIG. 5 is a schematic representation of a cross-section of the first end with a cap.

FIGS. 6, 7 and 8 are schematic representations of deformations in the tube with confined compression between the tube and the resin.

FIG. 9 is a schematic representation of a cross-section of a C-shaped tube filled with material.

FIG. 10 is a schematic representation of a cross-section of a spiral tube.

FIG. 11 is a schematic representation of a cross-section of a tube which is not welded.

FIG. 12 is a schematic representation of a cross-section of a C-shaped tube.

FIG. 13 is a schematic representation of a J-hook in the mine bolt.

FIG. 14 is a schematic representation of an anchor bolt being inserted into the mine bolt.

FIG. 15 is a schematic representation of a resin cartridge and rebar in a mine bolt.

FIG. 16 is a schematic representation of one type of an insertion tool in the second end of the tube.

FIG. 17 is a schematic representation of the mine bolt with a mesh holder holding a resin cartridge.

FIG. 18 is an alternative embodiment of one type of an insertion tool in the second end of the tube.

FIG. 19 is a schematic representation of a side view of the tube with deformations.

FIG. 20 is a schematic representation of another side view of the tube with deformations.

FIG. 21 is a sectional view of FIG. 20.

FIG. 22 is a sectional view of FIG. 20.

FIG. 23 is a sectional view of FIG. 21.

FIG. 24 is a schematic representation of the mine bolt.

FIG. 25 is a schematic representation showing the hollow mine bolt being deformed due to shifting of the rock.

FIG. 26 is a schematic representation of a side view of another embodiment of an insertion tool.

FIG. 27 is a sectional view of FIG. 26.

FIG. 28 is a sectional view of FIG. 26.

### DETAILED DESCRIPTION

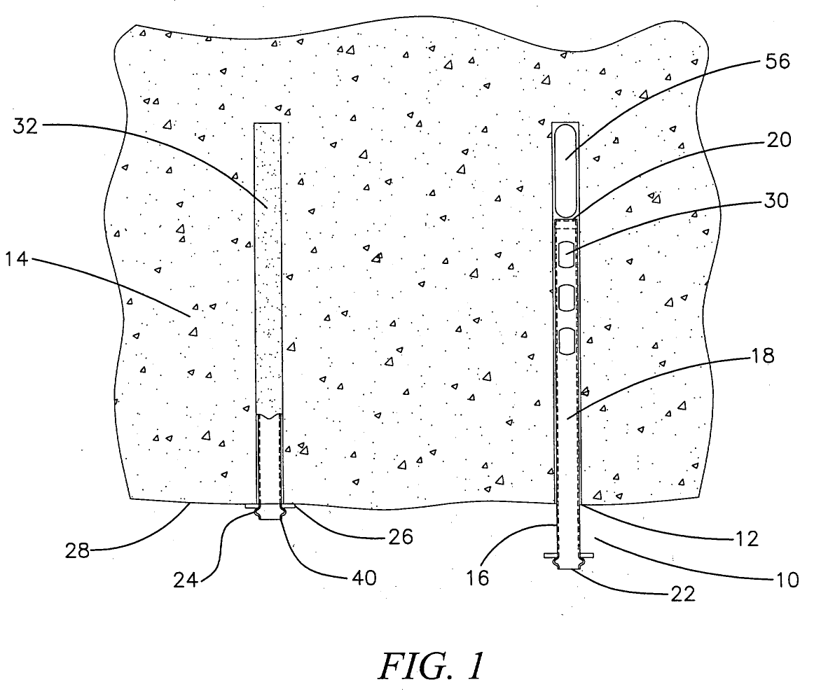

Referring now to the drawings wherein like reference numerals refer to similar or identical parts throughout the several views, and more specifically to FIG. 1 thereof, there is shown a grouted mine bolt 10 for a bore hole 12 in rock of a mine. The bolt comprises a tube 16 having a cross-sectional diameter less than that of the bore hole 12, a hollow interior 18, a first end 20, and a second end 22 having an opening in communication with the hollow interior 18. The bolt comprises a flange 24 disposed adjacent to the second end 22.

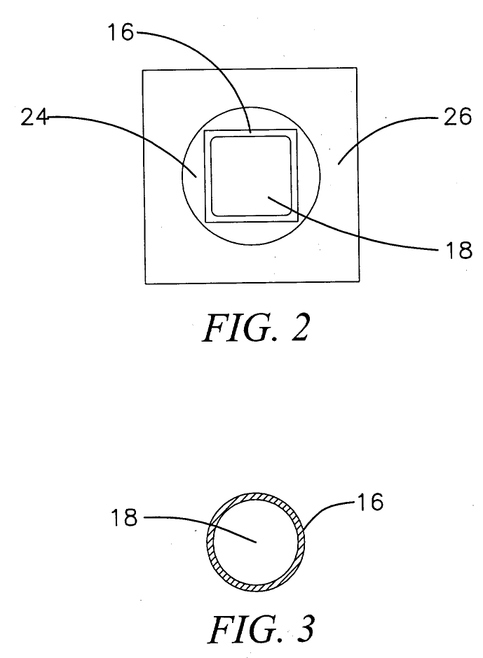

Preferably, the first end 20 is closed. The tube 16 preferably has a circular cross-section or has at least one flat side, as shown in FIG. 2. Preferably, the tube 16 has a closed perimeter, as shown in FIG. 3. The bolt preferably includes a bearing plate 26 adapted to be disposed between the flange 24 and the roof surface 28 when the tube 16 is in place in the bore hole 12. Preferably, the flange 24 holds the bearing plate 26 against at least 10,000 lbs. of load.

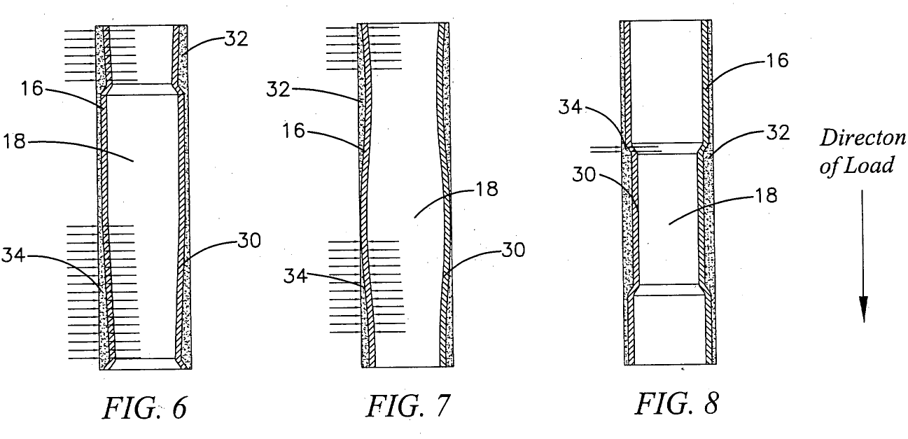

The tube 16 preferably has deformations 30 such that axial tension on the bolt flange 24 results in axial movement between the tube 16 and the resin 32 and results in compression of the resin 32 between the bore hole and the tube 16 surface to facilitate anchorage of the tube 16 with resin 32 to the mine rock in which the bore hole is disposed. Preferably, the deformations 30 form wedges 34 in the tube 16 that compress the resin 32 and place the tube 16 in compression when the tube 16 experiences axial tension, as shown in FIGS. 6, 7 and 8. The flange 24 is preferably formed from the tube 16, wherein the flange 24 and the tube 16 are one continuous piece.

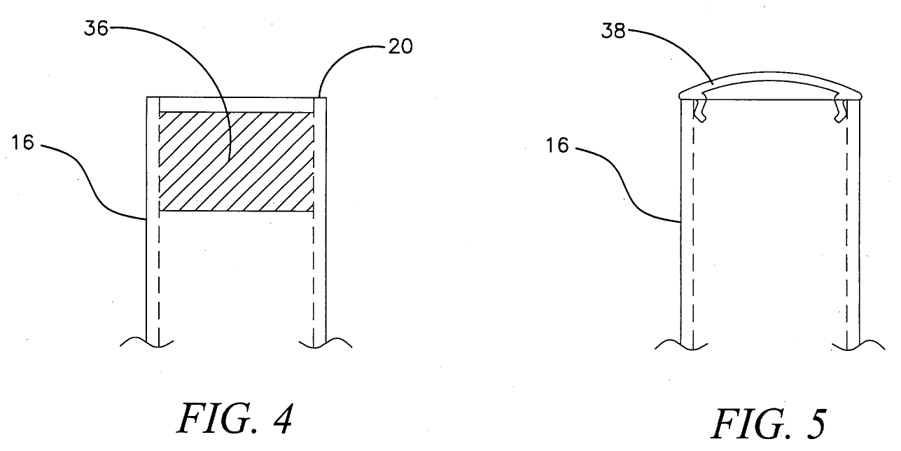

There can be a plug 36 disposed in proximity to the first end 20 to close the first end 20 of the tube 16, as shown in FIG. 4. Alternatively, or in addition, a cap 38 that fits to the first end 20 to close the first end 20 of the tube 16, as shown in FIG. 5, can be used. Preferably, the tube 16 has a lip 40 at the second end 22 disposed adjacent the flange 24, as shown in FIG. 1.

The tube 16 preferably has a maximum cross-sectional dimension less than that of the diameter of the bore hole 12 and a minimum cross-sectional area of 45% of the cross-sectional area of the bore hole 12. Preferably, the tube 16 surface is relatively smooth so that slip will occur between the bolt and resin 32 and not between the resin 32 and the bore hole 12, as shown in FIGS. 6, 7 and 8. The deformations 30 preferably have an angle in the tube 16 relative to the bolt's longitudinal axis less than 45 degrees, as shown in FIGS. 6, 7 and 8. Preferably, the deformations 30 have a depth of 1% to 40% of the tube 16 diameter.

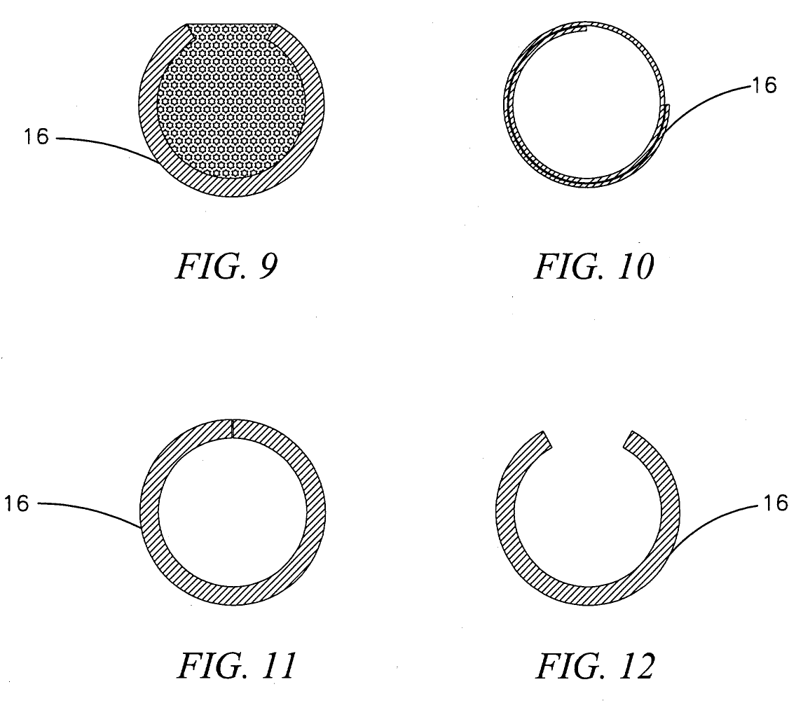

The second end 22 preferably has either a round, square, hexagon or octagon shaped cross-section. Preferably, the tube 16 is made from steel. The tube 16 can be coated or filled to reduce corrosion, as shown in FIG. 9. The tube 16 can be a metal plate rolled into a spiral, as shown in FIG. 10. Alternatively, the tube 16 has a first edge and a second edge spaced from the first edge, as shown in FIG. 11. The tube 16 can have a cross-sectional shape of a C, as shown in FIG. 12.

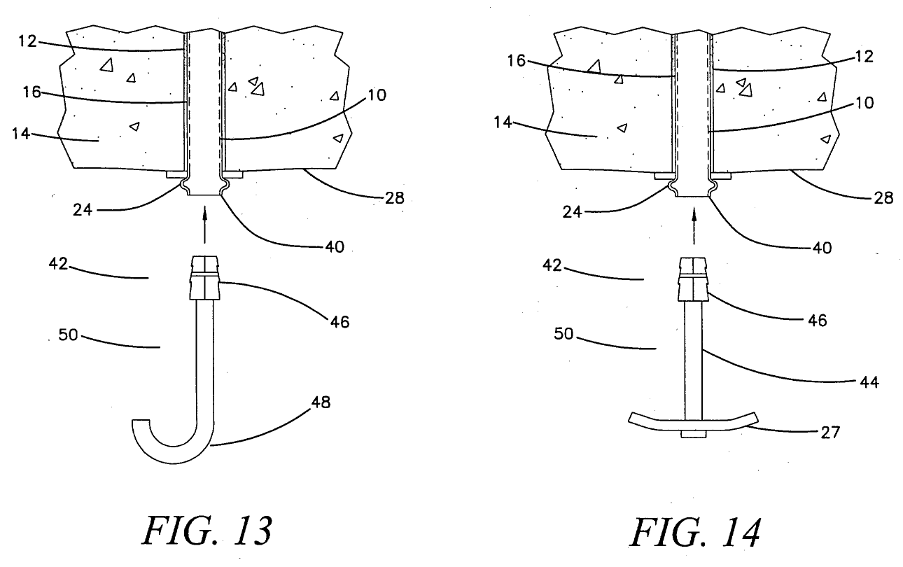

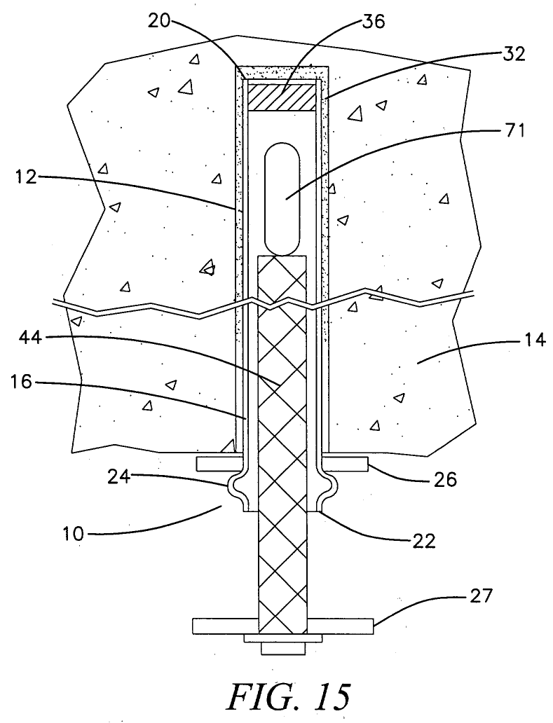

The bolt 50 can include an anchor means 42 disposed in the tube 16 and an elongated member in contact with the anchor means 42 and extending from the anchor means 42 out the second end 22 of the tube 16. The anchor means 42 can include an expansion anchor 46, and the elongated member 44 can include either a hook 48 or a bolt 50 extending from the expansion anchor 46 and out the second end 22 of the tube 16, as shown in FIGS. 13 and 14, respectively. The anchor means 42 can include resin 71 and the elongated member 44 can include rebar, as shown in FIG. 15.

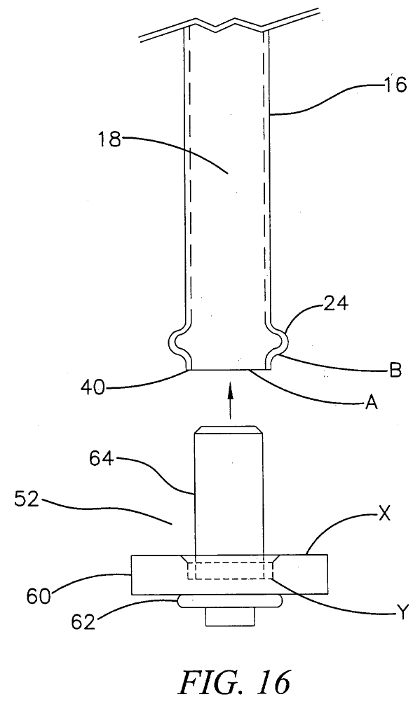

The present invention pertains to a method for supporting rock in a mine, as shown in FIG. 1. The method comprises the steps of breaking a resin cartridge 56 in a bore hole 12 in the rock with a first end 20 of a mine bolt 10. There is the step of rotating the tube 16 of the mine bolt 10 disposed in the bore hole from a second end 22 of the tube 16 with a bolting machine 54 connected to an insertion tool 52 that contacts the second end 22 and preferably extends into the hollow interior 18 of the tube 16 through an opening in the second end 22, as shown in FIG. 16.

Preferably, the breaking step includes the step of inserting the tube 16 into the bore hole until a bearing plate 26 in contact with a flange 24 in the tube 16 in proximity to the second end 22 contacts the surface 28 of the rock of the mine roof 14, as shown in FIG. 1. The inserting step preferably includes the step of moving the first end 20 of the tube 16 which is closed so resin 32 from the resin cartridge 56 will not enter the interior 18 of the tube 16 but flow along the outer surface of the tube 16 which has deformations 30 such that axial tension on the bolt flange 24 results in axial movement between the tube 16 and the resin 32 and result in compression of the resin 32 between the bore hole and the tube 16 surface to facilitate anchorage of the tube 16 with the mine roof 14 when the resin 32 between the tube 16 and the mine roof 14 sets. Preferably, there is the step of engaging the insertion tool 52 with the lip 40, the flange 24 and the interior 18 of the second end 22, as shown in FIG. 16.

There can be the step of implacing an elongated member 44 inside the tube 16. The implacing step can include the step of expanding an expansion anchor 46 inside the tube 16 from which the elongated member 44 extends out of the tube 16 through the second end 22, as shown in FIGS. 13 and 14.

The present invention pertains to a mine bolt 10 for insertion in a bore hole 12, as shown in FIGS. 13, 14 and 15. The bolt 10 comprises a tube 16 having a cross-sectional diameter less than that of the bore hole. The tube has a hollow interior 18, a first end 20, and a second end 22 having an opening in communication with the hollow interior 18, preferably through which a tool can be inserted to turn the tube 16 from the second end 22. The bolt 10 comprises a flange 24 disposed adjacent to the second end 22. The bolt comprises an anchor means 42 implaced in the tube 16. The bolt comprises an elongated member 44 disposed in the tube 16 and extending from the anchor means 42 out the tube 16 to the second end 22.

The present invention pertains to a method of forming a mine bolt 10. The method comprises the steps of swaging closed a first end 20 of a tube 16. There is the step of forming a flange 24 in the tube 16 in proximity to a second end 22 of the tube 16 while maintaining the second end 22 of the tube 16 open.

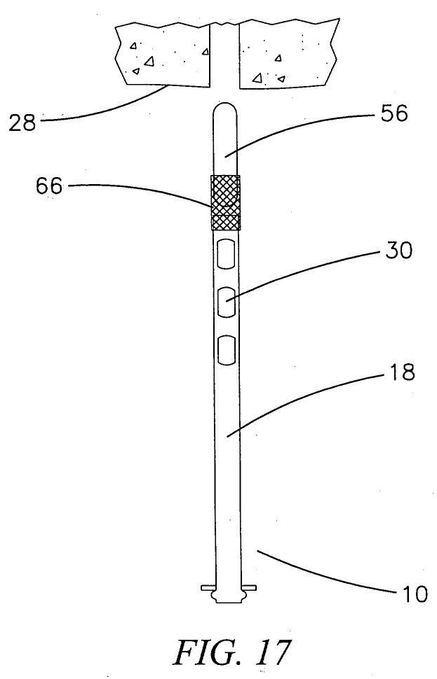

In the operation of the invention and as shown in FIG. 1, a bore hole is drilled into the rock face of the mine. The bore hole can be in the side wall of the mine or preferably in the roof of the mine. The bore hole has a length of 6 ft. 1 in. and a diameter of 1⅜ inches. Next, the resin cartridge 56 is inserted into the bore hole. Alternatively, the resin cartridge 56 can be placed on a plastic mesh holder 66 disposed on the first end 20 of the tube 16 of the mine bolt 10, as shown in FIG. 17. When the first end 20 of the tube 16 is then inserted into the bore hole, the resin cartridge 56 is automatically placed into the bore hole.

A method of attaching and supporting a grout cartridge contained in or partially contained by the mine bolt so that both the bolt and cartridge can be aligned and guided together for insertion in and fed to the bottom of the bore hole, thus eliminating a separate step. This also allows for ease of insertion in a bore hole that is remote from the operator's reach and provides additional safety for the operator by his not needing to insert the cartridge by hand or otherwise having to go out under unsupported roof. See FIG. 17 where 28 is the rock; 54 is the bolting machine; 52 is the insertion tool; 10 is the bolt; 56 is the grout cartridge of varying length and diameter and 66 is one of the methods of attaching, supporting and aligning the cartridge and bolt. An example of a holder 66 is S-1984 1 1/16″ ID Poly Net Sleeving 6″ long where one end of the sleeve fits over the bolt 10 and the other end of the sleeve fits over the cartridge allowing for containment and alignment of the bolt and cartridge before being placed into the bore hole and fed to the bottom of the bore hole. These sleeves can be obtained in various lengths and sizes dependent on the bolt diameter and cartridge diameter as may be specified. Refer to FIG. 17.

FIGS. 26, 27 and 28 show a preferred insertion tool 67 for tube 16 bolts that engages the “crimp” or flange 24 in the inside to the bolt to provide positive rotation. The flat section 69 on the end of the tool 67 engages the crimped partially flat section of the tube 16 and the head 71 of the tool 67 engages the second end of the tube 16 bolt to provide thrust for insertion. The advantage of this type of tool 67 is that the tensional forces are not applied on the head 71 in combination with insertion forces. This reduces the maximum stress and reduces the potential to over stress the head 71. This is especially important when the bolts are installed at high angles where a bending moment is induced in the tube 16 bolt due to misalignment between the roof bolting machine 54 and bolt.

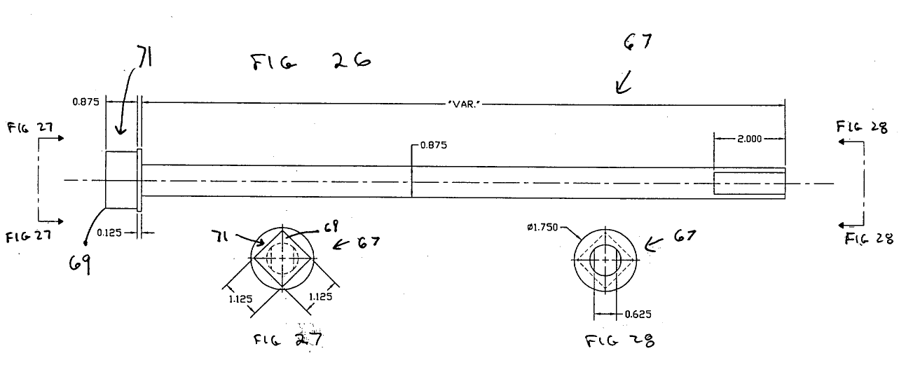

The insertion tool 67 is designed so that it engages the “crimped” portion of the tube 16 bolt closest to the second end 22. The design of the insertion tool 67 and crimped section of the tube 16 bolt can take many shapes that will provide the proper engagement to provide for rotation. FIGS. 26 and 27 show a simple flat section. One skilled in the art can easily device other shapes such as square, hex, torex, etc. that will provide the proper engagement.

The tube 16 of the mine bolt 10 is made of steel, has an outside diameter of 1¼ inches and is 0.095 inches thick. The first end 20 of the tube 16 has been swaged closed so that when the first end 20 punctures the resin cartridge 56, resin 32 does not enter the inside of the tube 16 and acts to pierce the resin cartridge 56 upon insertion, as shown in FIG. 1. Alternatively, the first end 20 can have a plug 36 made of plastic or wood or metal that seals the first end 20, as shown in FIG. 4. Instead, the plug 36 can be a cap 38 that is placed on the first end 20 to seal the first end 20 from resin 32 entering into it, as shown in FIG. 5.

The first end 20 of the tube 16 punctures the resin cartridge 56 and is moved through the resin cartridge 56 until the bearing plate 26, disposed on the flange 24 of tube 16, contacts the surface of the rock about the bore hole. The resin flows past the closed first end 20 along the bore hole and the tube. The set resin encapsulates at least one deformation, which is preferably at least 6 inches from the top of the first end. Preferably, the resin flows past all the deformations and encapsulates all the deformations.

The flange 24 is formed from the tube 16, in proximity to the second end 22, preferably in a hot forging process, although crimping of a metal washer, or welding of a metal washer or ring can also be used to form the flange 24 on the tube 16. The flange 24 has a 2 in. outside diameter and is designed to hold the bearing plate 26 and support at least a load of about 20,000 lbs.

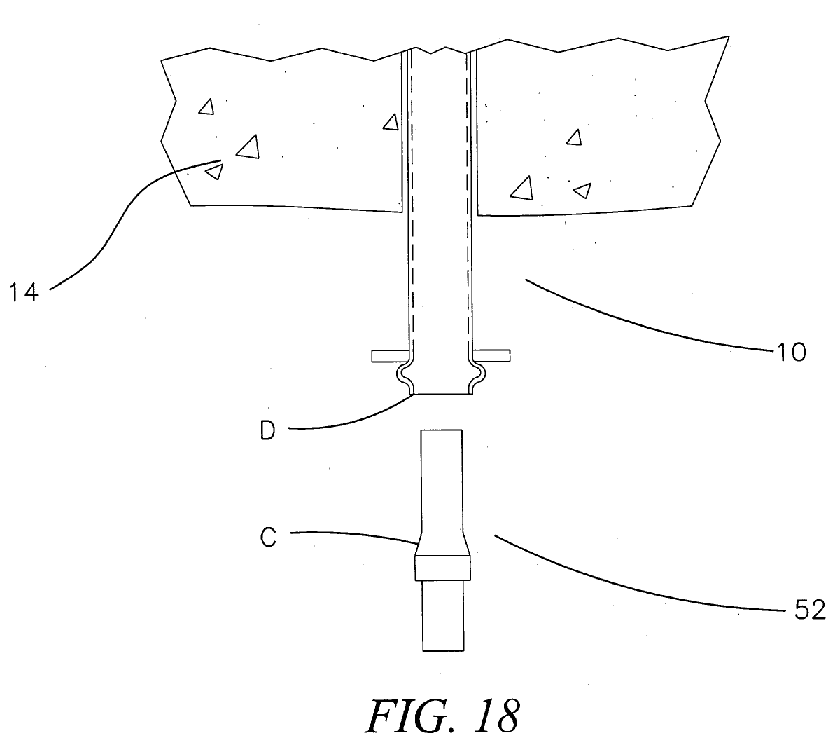

The second end 22 of the tube 16 is open with a preferably round cross section to allow an insertion tool 52 to turn the mine bolt 10 in the bore hole from the second end 22. Alternatively, the second end 22 can have a square or octagon shape. The lead 64 of the insertion tool 52 is inserted into the tube 16 at the lip 40 at the second end 22 of the tube 16. The lead 64 can also serve to balance the bolt on the insertion tool 52 as it is placed in the rock. The lip 40 is formed from the second end 22 of the tube 16 below the flange 24. An addition 60 to the shoulder 62 of the insertion tool 52 is of a shape that mates with the surface of the lip 40 and flange 24, as shown in FIG. 16. The surface X and the surface Y of the insertion tool 52 engages surface B and surface A, respectively, of the mine bolt 10. Alternatively, only surface A or surface B can be engaged, or the shoulder of the insertion tool can have a tapered surface C, as shown in FIG. 18, that frictionally engages surface D of the mine bolt 10. By having surface X and surface Y engage surface B and surface A, respectively, the friction and pressure applied to the mine bolt 10 from the insertion tool 52 during spinning absorbs the forces that are created to prevent the lip 40 of the bolt from flattening while it is being spun. The head of the insertion tool 52 fits with the chuck of a bolting machine 54. The bolting machine 54, when activated, spins the bolt by the insertion tool 52, frictionally gripping the mine bolt 10, and mixing the resin 32.

The tube 16 can be of any cross-section. Alternatively, the tube 16 can be formed of rolled shapes that are not tubes that have a closed circumference. The tube 16 can be round with the sides not welded, as shown in FIG. 11, or in the form of a C, as shown in FIG. 12. The tube 16 can be formed from a steel plate that is rolled into a spiral, as shown in FIG. 10. Alternatively, the hollow interior 18 of the tube 16 can be filled at the first end 20 for about 1 to 2 inches, or completely filled, as shown in FIG. 9. The material used to fill the hollow section can be foam, concrete, epoxy, polyester or resin 32, to name but a few of the possible materials. The advantage of filling the tube 16 interior 18 is to reduce or prevent corrosion. For example, if the tube 16 is filled with low density foam, corrosion of the interior 18 surface of the tube 16 would be eliminated and an anchor for hanging objects could be inserted in the head end if the foam is soft enough to be displaced. Foam polymers would essentially not change the weight of the bolt. Alternatively, the interior 18 surface of the tube 16 can be coated with a material to also prevent corrosion.

There are several techniques for inhibiting corrosion in the steel tube bolt. These include using coatings with the tube bolt such as:

Painting (a wide variety of paints will work)

Oil coatings

Silicon coatings

Galvanization

Moreover, sacrificial zinc can be added to the tubular bolt, or the interior of the tube bolt can be filled with polyester foam. The coatings can likely be applied by spraying or dipping. Polyester foam can be injected into the interior. The zinc could be the plug in the end. This will protect the steel because the zinc is more reactive (and will corrode preferentially) than the steel bolt. This form of corrosion protection is known as cathodic protection.

As mentioned above, the interior 18 of the tube 16 bolt can be used to hang objects, such as a J-hook 48, as shown in FIG. 13, or an anchor bolt 50, as shown in FIG. 14. In a first embodiment for hanging a J-hook 48 or an anchor bolt 50, an expansion anchor 46 is inserted into the tube 16 bolt through the second end 22 to a point with an essentially constant inside diameter for a secure anchorage to the tube 16 bolt interior 18. The expansion anchor 46 is then expanded to fix it to the tube 16 bolt. From the expansion anchor 46, the J-hook 48 can extend down and hang out the second end 22 of the tube 16 bolt from which water lines or other objects can be hung, or rebar can extend from the expansion anchor 46 with a bearing plate attached to the bottom of the rebar to add additional bolt strength to the tube 16 bolt. In another embodiment, instead of an expansion anchor 46 being used, resin 32 can be used to hold the J-hook 48 or the rebar of the anchor bolt 50. A resin cartridge 71 is inserted into the interior 18 of the tube 16 through the second end 22 and the J-hook 48 or the rebar of the anchor bolt 50 is then inserted into the tube 16 bolt through the second end 22, puncturing the resin cartridge 71. The J-hook 48 or the anchor bolt 50 is then fixed in place with the resin 32, as it is commonly done from a bore hole 12.

The deformations 30 necessary to achieve superior holding power must be made such that axial tension on the bolt flange 24 results in axial movement between the tube 16 and the resin 32 and result in confined/semi-confined compression of the resin 32 between the bore hole and tube 16 surface. The deformations 30 are made so that they form wedges 34 that compress the resin grout 32 and place the tube 16 in compression. The tube 16 surface must be relatively smooth so it slips in the resin 32 and provides confined compression of the resin 32. In other words, the resin 32 must not adhere to the tube 16, the tube 16 must slip slightly through the resin 32. Once it starts to slip, it acts like a “Chinese handcuff”, the harder you pull, the higher the strength.

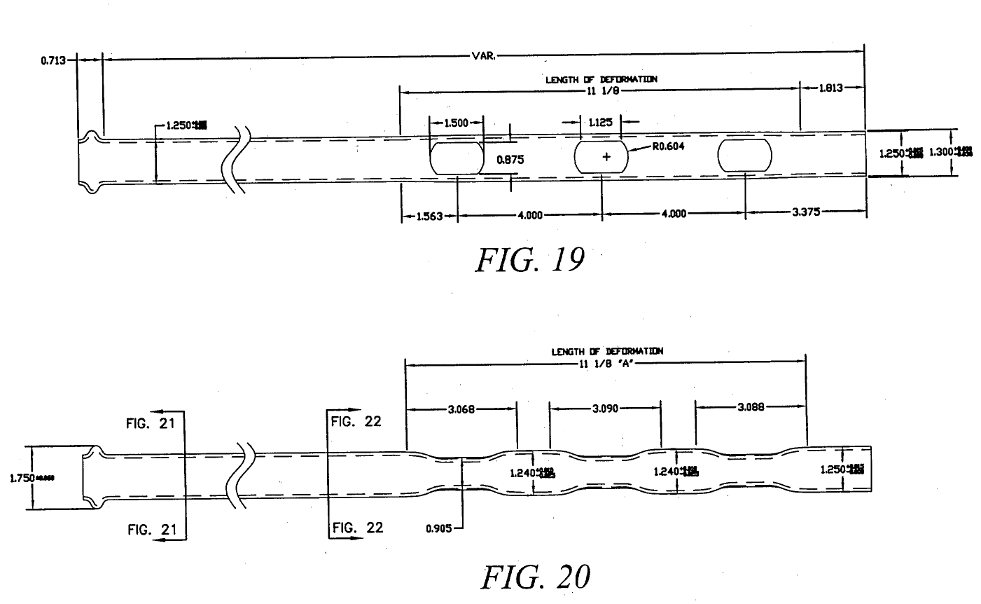

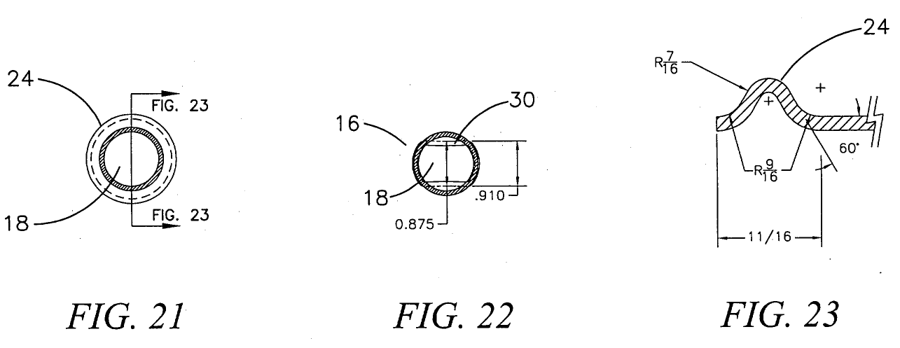

The deformations 30 should be made in the tube 16 so that the angle of the deformation 30 made relative to the bolt axis is less than 45 degrees and preferably less than 10 degrees, as shown in FIGS. 6, 7 and 8. This assures that the resin 32 will be in confined compression instead of shearing. The depth of the deformation 30 should be in the range of 0.010 inches to 0.300 inches. The number of deformations 30 should be no more than 12 per foot and no less than 1 per foot of bolt length, as shown in FIGS. 19-23. This type of deformation 30 is desirable in solid bolts also.

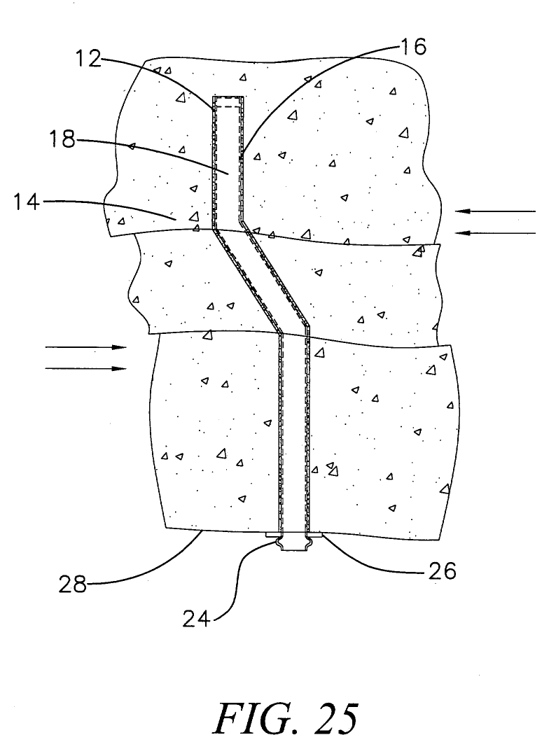

Another key advantage of the bolt is its ability to absorb substantially more energy than a solid bolt. A solid bolt will absorb energy as the steel yields plastically. The bolt with the deformations 30 will absorb energy as the steel yields and additionally absorb energy as the tube 16 deforms or crushes. This crushing energy or deformation 30 energy can be substantial and provides superior roof support, as shown in FIG. 25.

The deformation 30 pattern on the first end 20 of the tube 16 is cold formed using a 50 ton, adjustable stroke, high speed hydraulic press. Upon actuating the ram, two containment dies are closed together simultaneously. When closed these two matching die halves contain the OD of the tubing while approximately 40 tons of force is used to form the deformation 30 pattern. The containment die is a circumferential die with a bore diameter of 1.300″. The deformation 30 pattern is created by the continuing stroke of the press which closes two duplicate forming dies onto the tubing, 180 degrees apart. The forming dies are made up of three 1½ diameter circular pins equally spaced at 4″ center-to-center. These pins indent/deformation 30 the tube 16 with a 3/16 deep oval pattern. These forming dies compress the tubing to form a similar three deformation 30 pattern on opposite sides of the tube 16. The press then cycles back on top, opens the dies and the tube 16 is removed from the die set with the completed deformation 30 pattern in place.

The bead or flange 24 on the second end 22 of the bolt is hot formed using an induction heating process and a hydraulic forging machine. Approximately 1¾″ of the tube 16 end is inserted into an induction heating coil to heat the tube 16 end to a nominal temperature of 1525 degrees Fahrenheit. The tube 16 is then placed into the hydraulic forging machine which forces the heated tube 16 end into a forming die with a resultant force of approximately 15,000 pounds. This axial movement of the tube 16 into the forming die causes the midpoint of the heated area to bulge/deform outwards and form the beaded end. The contours and dimensions of the beaded end are controlled by the following; steel tubing properties, the length of stroke of the hydraulic forging machine, the length of the heat affected zone and the level of heat induced into the tubing end. After forming the beaded end, the tube 16 is removed from the forging machine and is immediately submersed into a cooling tank filled with water to quench the tube 16 and establish a microstructure which gives the end ductility for resistance to failure. Additional information regarding the deformations can be found in U.S. patent application Ser. No. ______ titled “Mine Bolt With Deformations and Method”.

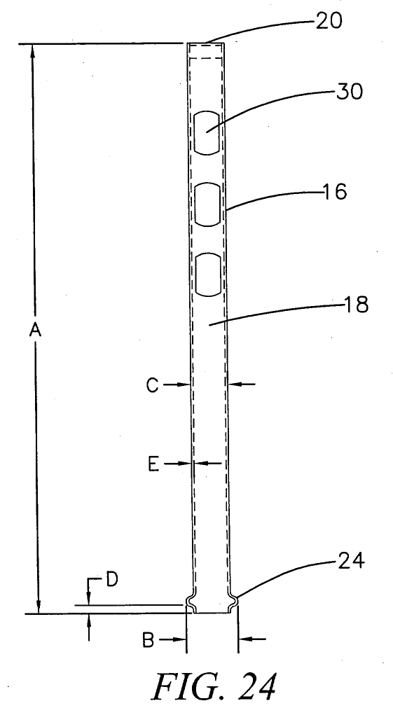

The dimensions of the mine bolt 10, as represented by the reference letters in FIG. 24, preferably fall within the following range, but are not limited thereto.

A 12″-50′

B O.D.+(O.D.×0.45)

C ½″-3″

D ¾″-2″

E 0.06″-0.30″

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. A grouted mine bolt for a bore hole in rock of a mine comprising:
a tube having a cross-sectional diameter less than that of the bore hole, a hollow interior, a first end, and a second end having an opening in communication with the hollow interior; and
a flange disposed adjacent to the second end.

2. A bolt as described in claim 1 wherein the first end is closed.

3. A bolt as described in claim 2 wherein the tube has a circular cross-section or has at least one flat side.

4. A bolt as described in claim 3 wherein the tube has a closed perimeter.

5. A bolt as described in claim 4 including a bearing plate adapted to be disposed between the flange and the rock surface when the tube is in place in the bore hole.

6. A bolt as described in claim 5 wherein the flange holds the bearing plate against at least 10,000 lbs. of load.

7. A bolt as described in claim 6 wherein the tube has deformations such that axial tension on the bolt flange results in axial movement between the tube and the resin and result in compression of the resin between the bore hole and the tube surface to facilitate anchorage of the tube with resin to the mine rock in which the bore hole is disposed.

8. A bolt as described in claim 7 wherein the deformations form wedges in the tube that compress the resin and place the tube in compression when the tube experiences axial tension.

9. A bolt as described in claim 8 wherein the flange is formed from the tube, wherein the flange and the tube are one continuous piece.

10. A bolt as described in claim 9 including a plug that is disposed in proximity to the first end to close the first end of the tube.

11. A bolt as described in claim 9 including a cap that fits to the first end to close the first end of the tube.

12. A bolt as described in claim 11 wherein the tube has a lip at the second end disposed adjacent the flange.

13. A bolt as described in claim 12 wherein the tube has a maximum cross-sectional dimension less than that of the diameter of the bore hole and a minimum cross-sectional area of 45% of the cross-sectional area of the bore hole.

14. A bolt as described in claim 13 wherein the tube surface is relatively smooth so that slip will occur between the bolt and resin and not between the resin and the bore hole.

15. A bolt as described in claim 14 wherein the deformations have an angle in the tube relative to the bolt's longitudinal axis less than 45 degrees.

16. A bolt as described in claim 15 wherein the deformations have a depth of 1% to 40% of the tube diameter.

17. A bolt as described in claim 16 wherein the second end has either a round, square, hexagon or octagon shaped cross-section.

18. A bolt as described in claim 17 wherein the tube is made from steel.

19. A bolt as described in claim 18 wherein the inside of the tube is coated or filled to reduce corrosion.

20. A bolt as described in claim 3 wherein the tube is a metal plate rolled into a spiral.

21. A bolt as described in claim 3 wherein the tube has a first edge and a second edge spaced from the first edge.

22. A bolt as described in claim 22 wherein the tube has a cross-sectional shape of a C.

23. A bolt as described in claim 16 including an anchor means disposed in the tube and an elongated member in contact with the anchor means and extending from the anchor means out the second end of the tube.

24. A bolt as described in claim 23 wherein the anchor means includes an expansion anchor, and the elongated member includes either a hook or an anchor bolt extending from the expansion anchor and out the second end of the tube.

25. A bolt as described in claim 23 wherein the anchor means includes resin.

26. A bolt as described in claim 25 wherein the elongated member includes rebar.

27. A method for supporting rock in a mine comprising the steps of:
breaking a resin cartridge in a bore hole in the rock with a first end of a mine bolt; and
rotating the tube of the mine bolt disposed in the bore hole from a second end of the tube with a bolting machine connected to an insertion tool that contacts and is disposed in the second end.

28. A method as described in claim 27 wherein the breaking step includes the step of inserting the tube into the bore hole until a bearing plate in contact with a flange in the tube in proximity to the second end contacts the surface of the rock.

29. A method as described in claim 28 wherein the inserting step includes the step of moving the first end of the tube which is closed through the resin cartridge so resin from the resin cartridge will not enter the interior of the tube but flow along the outer surface of the tube which has deformations such that axial tension on the bolt flange results in axial movement between the tube and the resin and result in compression of the resin between the bore hole and the tube surface to facilitate anchorage of the tube with the rock when the resin between the tube and the rock sets.

30. A method as described in claim 29 including the step of engaging the insertion tool with the lip, the flange and the interior of the second end.

31. A method as described in claim 30 including the step of implacing an elongated member inside the tube.

32. A method as described in claim 31 wherein the implacing step includes the step of expanding an expansion anchor inside the tube from which the elongated member extends out of the tube through the second end.

33. A method as described in claim 31 wherein the implacing step includes the steps of placing a resin cartridge in the bore hole, and breaking the resin cartridge with the elongated member.

34. A mine bolt for a bore hole in rock of a mine comprising:
a tube having a cross-sectional diameter less than that of the bore hole, a hollow interior, a first end, and a second end having an opening in communication with the hollow interior;
a flange disposed adjacent to the second end;
an anchor means implaced in the tube; and
an elongated member disposed in the tube and extending from the anchor means out the tube to the second end.

35. A method of forming a mine bolt comprising the steps of:
swaging closed a first end of a tube; and
forming a flange in the tube in proximity to a second end of the tube while maintaining the second end of the tube open.

36. A grouted mine bolt for a bore hole in rock of a mine comprising:
an elongate member having a cross-sectional diameter less than that of the bore hole, a first end, and a second end;
a resin cartridge holder for holding a resin cartridge, the holder connected to the first end; and
a flange disposed adjacent to the second end.
